(19) United States
(12) Patent Application Publication
(10) Pub. No.: US 2022/0138466 A1
(43) Pub. Date: May 5, 2022

(54) DYNAMIC VISION SENSORS FOR FAST MOTION UNDERSTANDING

(71) Applicant: SAMSUNG ELECTRONICS CO., LTD., Suwon-si (KR)

(72) Inventors: Anthony Robert BISULCO, New York, NY (US); Fernando Cladera Ojeda, Philadelphia, PA (US); Ibrahim Volkan Isler, Saint Paul, MN (US); Daniel Dongyuel Lee, Tenafly, NJ (US)

(73) Assignee: SAMSUNG ELECTRONICS CO., LTD., Suwon-si (KR)

(21) Appl. No.: 17/328,518

(22) Filed: May 24, 2021

Related U.S. Application Data
(60) Provisional application No. 63/109,996, filed on Nov. 5, 2020.

(51) Int. Cl. G06K 9/00; G06T 7/80; G06T 7/215; G06T 7/62

(52) U.S. Cl. CPC G06K 9/00664; G06T 7/80; G06T 7/215; G06T 2207/20076; G06T 2207/20084; G06T 2207/20081; G06T 2207/30241; G06T 7/62

(57) ABSTRACT

An apparatus for motion understanding, includes a memory storing instructions, and at least one processor configured to execute the instructions to obtain, from a dynamic vision sensor, a plurality of events corresponding to an object moving with respect to the dynamic vision sensor, and filter the obtained plurality of events, using a plurality of exponential filters integrating over different time periods, to obtain a plurality of representations of the object moving with respect to the dynamic vision sensor. The at least one processor is further configured to execute the instructions to filter the obtained plurality of representations, using a convolution neural network, to obtain a probability of the object impacting a location on the dynamic vision sensor.

### CROSS-REFERENCE TO RELATED APPLICATION

This application is based on and claims priority under 35 U.S.C. § 119 from U.S. Provisional Application No. 63/109,996 filed on Nov. 5, 2020, in the U.S. Patent & Trademark Office, the disclosure of which is incorporated by reference herein in its entirety.

### BACKGROUND

### 1. Field

The disclosure relates to dynamic vision sensors for fast motion understanding.

### 2. Description of Related Art

Mobile robotic systems may operate in a wide range of environmental conditions including farms, forests, and caves. These dynamic environments may contain numerous fast moving objects, such as falling debris and roving animals, which mobile robots may need to sense and respond to accordingly. The performance criteria for operating in such scenarios may require sensors that have fast sampling rates, good spatial resolution and low power requirements. Active sensor solutions such as structured light or Time-of-Flight (ToF) sensors may fail to meet the criteria due to their high power consumption and limited temporal resolution. An alternative approach may be to track objects with conventional cameras by explicitly computing dense optical flow in time. However, these algorithms may require computing dense feature correspondences, and the heavy processing requirements may limit overall system performance.

### SUMMARY

In accordance with an aspect of the disclosure, there is provided an apparatus for motion understanding, the apparatus including a memory storing instructions, and at least one processor configured to execute the instructions to obtain, from a dynamic vision sensor, a plurality of events corresponding to an object moving with respect to the dynamic vision sensor, and filter the obtained plurality of events, using a plurality of exponential filters integrating over different time periods, to obtain a plurality of representations of the object moving with respect to the dynamic vision sensor. The at least one processor is further configured to execute the instructions to filter the obtained plurality of representations, using a convolution neural network, to obtain a probability of the object impacting a location on the dynamic vision sensor.

In accordance with an aspect of the disclosure, there is provided a method of fast motion understanding, the method including obtaining, from a dynamic vision sensor, a plurality of events corresponding to an object moving with respect to the dynamic vision sensor, and filtering the obtained plurality of events, using a plurality of exponential filters integrating over different time periods, to obtain a plurality of representations of the object moving with respect to the dynamic vision sensor. The method further includes filtering the obtained plurality of representations, using a convolution neural network, to obtain a probability of the object impacting a location on the dynamic vision sensor.

In accordance with an aspect of the disclosure, there is provided a training method for fast motion understanding, the training method including performing spatial calibration of a dynamic vision sensor by controlling an array of light-emitting diodes (LEDs) to blink at a predetermined frequency and then controlling the dynamic vision sensor to track a position of a calibration board including a plurality of reflective markers. The training method further includes, based on the spatial calibration being performed, for each of a plurality of objects moving with respect to the dynamic vision sensor, performing temporal calibration of the dynamic vision sensor and a motion capture system by controlling the array of LEDs to blink, and based on the temporal calibration being performed, controlling the dynamic vision sensor to record a representation of a motion of a respective one of the plurality of objects. The training method further includes, based on the recorded representation of the motion of each of the plurality of objects, training a convolutional neural network to obtain a probability of a moving object impacting a location on the dynamic vision sensor.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a diagram illustrating motion understanding of a time to collision and a collision location of a fast moving object, using a dynamic vision sensor (DVS) spatiotemporal event volume, according to embodiments;

FIG. 2 is a block diagram of an apparatus for fast motion understanding, according to embodiments;

FIG. 3 is a detailed block diagram of the apparatus of FIG. 2;

FIG. 4 is a diagram of the apparatus of FIG. 2 processing three-dimensional (3D) volumes of DVS events, two-dimensional (2D) images and a concatenated 3D volume of images;

FIG. 5 is a flowchart of a method of fast motion understanding, according to embodiments;

FIG. 6 is a diagram of an experimental setup for data acquisition of a toy dart dataset, according to embodiments;

FIG. 7 is a diagram of an augmentation procedure of shifting impact location or rotation about an optical axis, according to embodiments;

FIG. 8 is a block diagram of an electronic device in which the apparatus of FIG. 2 is implemented, according to embodiments;

FIG. 9 is a diagram of a system in which the apparatus of FIG. 2 is implemented, according to embodiments; and

FIG. 10 is a flowchart a training method for fast motion understanding, according to embodiments.

### DETAILED DESCRIPTION

DVSs are biologically-inspired vision sensors that provide near continuous sampling and good spatial resolution at low power. Insects such as Drosophilia are able to quickly and accurately react to fast approaching objects via recognition of critical spatiotemporal motion patterns. Embodiments described herein seek to construct an efficient vision system that is able to respond to moving objects with speeds greater than 15 m/s, and with diameters as small as 2 cm.

A DVS measures asynchronous changes in light intensity rather than performing full synchronous readouts of the pixel array as with conventional complementary metal-oxide-semiconductor (CMOS)-based sensors. A DVS outputs a stream of events E={eᵢ} where each event can be described as a vector eᵢ=(x, y, p, t). x and y describe the image pixel location, p is for polarity that is the sign of the light change, and t is the time at which the event occurs.

The embodiments address the problem of predicting the time to collision and impact location of a fast approaching object from the DVS event stream. The embodiments include encoding motion and extracting relevant spatiotemporal features, using a bank of exponential filters with a convolutional neural network (CNN). The embodiments are able to yield robust estimates for the predicted time and location of the future impact without needing to compute explicit feature correspondences.

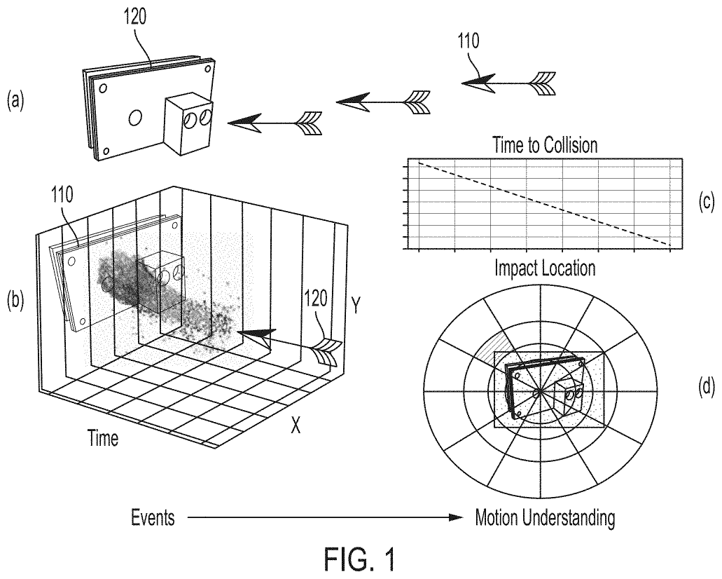

FIG. 1 is a diagram illustrating motion understanding of a time to collision and an impact location of a fast moving object, using a DVS spatiotemporal event volume, according to embodiments.

As shown in portion (a) of FIG. 1, a projectile 110 moves toward a DVS 120. Portion (b) of FIG. 1 shows a volume of events that is generated by the DVS 120, the events indicating how the projectile 110 is moving toward the DVS 120.

As shown in portions (c) and (d) of FIG. 1, the embodiments obtain and output potential coordinates of the impact location of the projectile 110 on a polar grid on a surface plane of the DVS 120 and centered at the DVS 120. The embodiments further obtain and output the potential time to collision of the projectile 110 to the camera plane of the DVS 120.

To obtain the impact location and the time to collision, the embodiments include a set of causal exponential filters across multiple time scales that obtains an event stream from the DVS 120, and encodes temporal events. These filters are coupled with a CNN to efficiently extract relevant spatiotemporal features from the encoded events. The combined network learns to output both the expected time to collision of the projectile 110 and the predicted impact location on the discretized polar grid. The network computes these estimates with minimal delay so an object (e.g., a robot) including the DVS 120 can react appropriately to the incoming projectile 110.

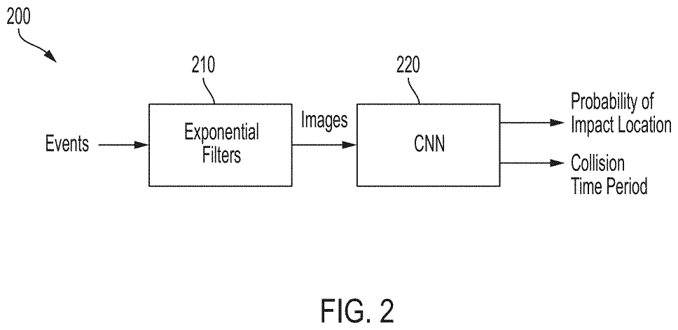

FIG. 2 is a block diagram of an apparatus 200 for fast motion understanding, according to embodiments.

The apparatus 200 and any portion of the apparatus 200 may be included or implemented in a client device and/or a server device. The client device may include any type of electronic device, for example, a smartphone, a laptop computer, a personal computer (PC), a smart television and the like.

As shown in FIG. 2, the apparatus 200 includes exponential filters 210 and a CNN 220.

The exponential filters 210 obtain, from a dynamic vision sensor, a plurality of events corresponding to an object moving with respect to the dynamic vision sensor. The exponential filters 210 further filter or encode the obtained plurality of events, by integrating over different time periods, to obtain a plurality of representations (images) of the object moving with respect to the dynamic vision sensor.

By using a bank of the exponential filters 210, the apparatus 200 can obtain a bigger sample of events of the dynamic vision sensor, to observe motions or optical flows of different types of objects.

The CNN 220 filter the obtained plurality of representations to obtain a probability of the object impacting a location on the dynamic vision sensor, and obtain a collision time period τ from a time at which the object is sensed by the dynamic vision sensor to a time at which the object impacts the location on the dynamic vision sensor. The impact location on the dynamic vision sensor may be in polar coordinates (R, θ) of a plane (i.e., chip surface or flat portion) of the dynamic vision sensor, and may be used as a predicted location. The obtained collision time period may be used as a predicted collision time period. Both the predicted location and collision time period may be referred to as spatiotemporal features that are extracted from the obtained plurality of representations.

A coordinate system defines +Z to be perpendicular to the plane of the dynamic vision sensor, and the dynamic vision sensor is defined as the origin. Therefore, the impact location and collision time period can be extracted when Z_{object}=0 (when the object is located in the plane of the dynamic vision sensor). After calculating the impact location, the collision time period may be used to calculate a collision time period for each previously-indexed location i on the plane of the dynamic vision sensor, as τ=Tᵢ−T_{impact}.

Each of the exponential filters 210 integrates an input signal in a time-windowed region with an exponential kernel:

y[n]=ay[n−1]+(1−α)x[n] (1),

where y[n] is an output signal, x[n] is the input signal, α is a smoothing factor (0<α<1) and n is a unit of discrete time.

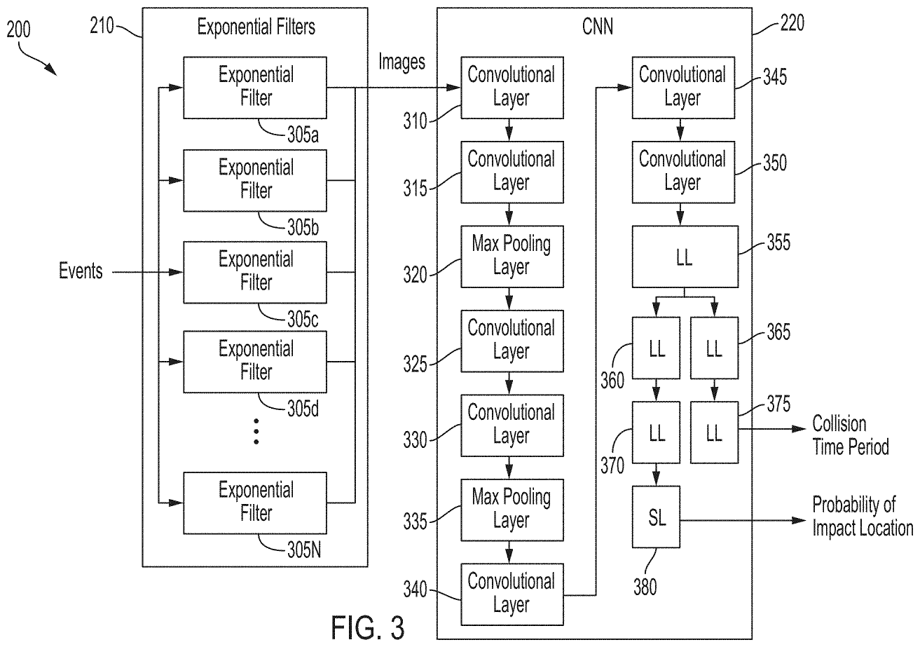

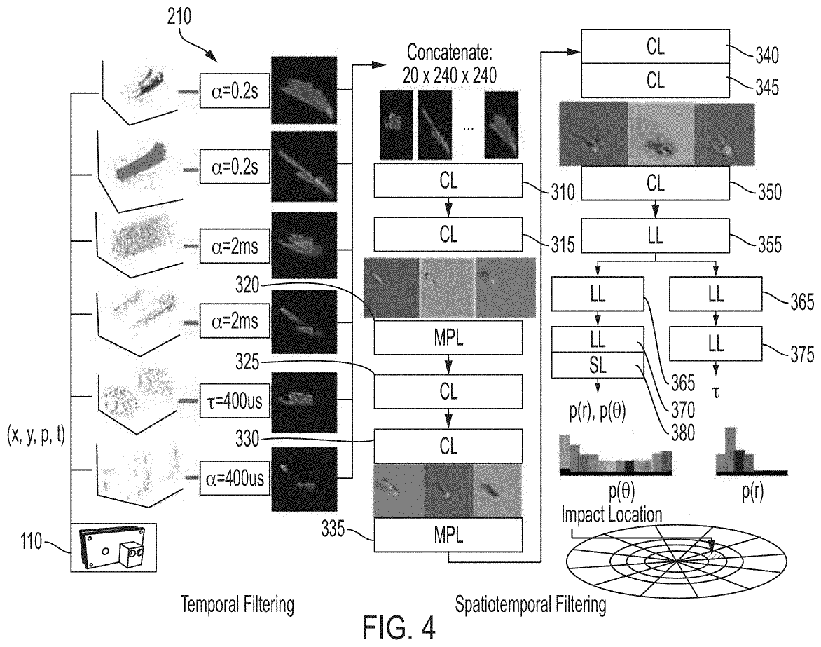

FIG. 3 is a detailed block diagram of the apparatus 200 of FIG. 2. FIG. 4 is a diagram of the apparatus 200 of FIG. 2 processing 3D volumes of DVS events, 2D images and a concatenated 3D volume of images.

As shown in FIGS. 3 and 4, the exponential filters 210 include exponential filters 305a to 305N. The CNN 220 includes convolutional layers (CLs) 310, 315, 325, 330, 340, 345 and 350, max pooling layers (MPLs) 320 and 335, linear layers (LLs) 355, 360, 365, 370 and 375 and a softmax layer (SL) 380.

Referring to FIGS. 3 and 4, the exponential filters 210 serve as a temporal filter including a bank of the exponential filters 305a to 305N respectively integrating the input 3D volumes of DVS events over different time periods or windows. For example, there may be 10 different exponential filters αᵢ that encode motion over periods of 200 μs, 477 μs, 1.13 ms, 2.71 ms, 6.47 ms, 15.44 ms, 36.84 ms, 87.871 ms, 0.2 s and 0.5 s, respectively.

An exponential filter may be implemented for each pixel on an image grid. Separate filters may be applied to positive and negative polarity channels creating, for example, 20×240×240 outputs per time step. Each filter may be updated every 200 μs, which is the time step. Outputs of the exponential filter every 200 μs may be temporally correlated, hence the filter may be regulated to output every 3 ms for a ball and every 1 ms for a toy dart. After temporal downsampling of the outputs, a 2× spatial downscale and a center crop may be performed on the outputs. Additionally, the outputs may be linearly discretized for a reduced memory footprint to an unsigned integer (8 bits).

The exponential filters 305a to 305N respectively generate the 2D images corresponding to the time windows of the 3D volumes of DVS events, and concatenate the generated 2D images into the concatenated 3D volume of images. A tensor of dimensions 20×240×240 that is issued from the exponential filters 210 is used as an input of the CNN 220.

The next step in the processing pipeline is to perform spatiotemporal feature extraction. The CNN 220 serves as spatiotemporal filters that outputs a time period to collision and coordinates of an impact of an object on a polar grid of a plane on the DVS. The convolutional layers 310, 315, 325, 330, 340, 345 and 350 or kernels emulate spatiotemporal feature extraction to interpret motion volume. The CNN 220 further includes the two 2x max pooling layers 320 and 335 and two readout networks, one for obtaining the time period to collision (including the linear layers 365 and 375) and one for estimating (p(r), p(θ)) (including the linear layers 355, 360 and 370 and the softmax layer 380). θ may be discretized into 12 bins each 30 degrees, and R may be discretized into 4 bins corresponding to {0 mm-60 mm, 60 mm-91 mm, 91 mm-121 mm, 121 mm-∞}.

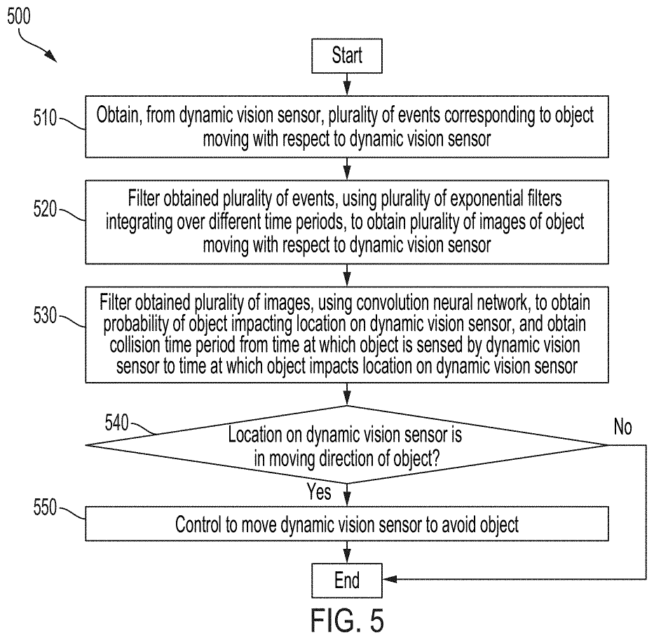

FIG. 5 is a flowchart of a method 500 of fast motion understanding, according to embodiments.

The method 500 may be performed by at least one processor using the apparatus 200 of FIG. 2.

As shown in FIG. 5, in operation 510, the method 500 includes obtaining, from a dynamic vision sensor, a plurality of events corresponding to an object moving with respect to the dynamic vision sensor.

In operation 520, the method 500 includes filtering the obtained plurality of events, using a plurality of exponential filters integrating over different time periods, to obtain a plurality of representations (images) of the object moving with respect to the dynamic vision sensor.

In operation 530, the method 500 includes filtering the obtained plurality of representations, using a convolution neural network, to obtain a probability of the object impacting a location on the dynamic vision sensor, and obtain a collision time period from a time at which the object is sensed by the dynamic vision sensor to a time at which the object impacts the location on the dynamic vision sensor.

In operation 540, the method 500 includes determining whether the location on the dynamic vision sensor is in a moving direction of the object. In response to the location on the dynamic vision sensor being determined to be in moving direction of the object, the method 500 continues in operation 550. Otherwise, the method 500 ends.

In operation 550, the method 500 includes controlling to move the dynamic vision sensor to avoid the object. For example, the dynamic vision sensor may be disposed on a robot, which may be controlled to move the dynamic vision sensor to avoid the object. The obtained collision time period may be integrated until a minimum actuation time period, and the dynamic vision sensor may be controlled to move to avoid the object, based on the minimum actuation time period.

Referring again to FIG. 2, supervised training is performed on the CNN 220. Thus, a dataset of states of objects and DVS events are collected for the training. To expand the dataset and enhance performance of the CNN 220, a set of augmentations are applied to the DVS events.

A process or collecting the dataset includes acquiring a series of DVS recordings while the objects are approaching a DVS. For example, the objects may include two types of objects: falling balls and toy darts. A falling ball dataset may be obtained by dropping spherical markers to the DVS. A toy dart dataset may be obtained by shooting darts to the DVS.

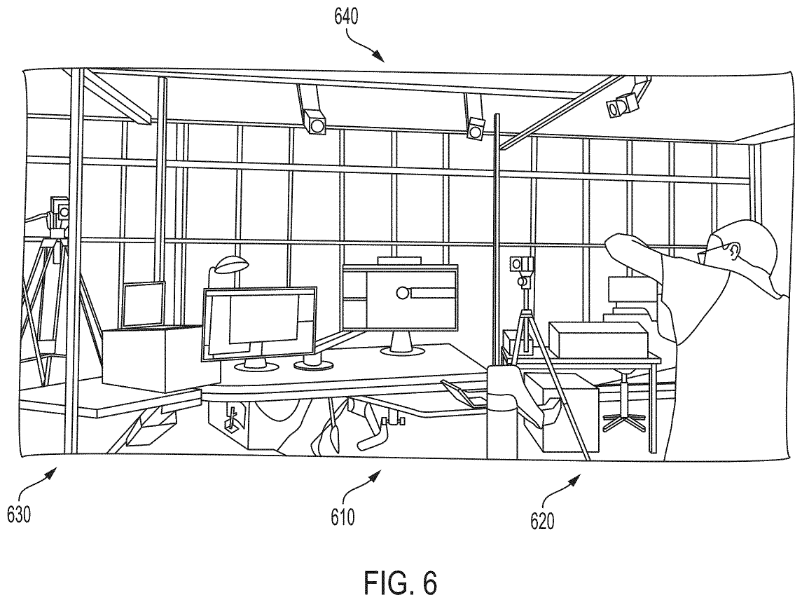

FIG. 6 is a diagram of an experimental setup for data acquisition of a toy dart dataset, according to embodiments.

Referring to FIG. 6, darts 610 having reflective markers are shot by a toy gun 620 toward a DVS 630. Motions of the darts 610 are tracked using a motion capture system 640 while they are recorded with the DVS 630.

To ensure proper tracking and temporal synchronization between data that is recorded with the DVS 630 and the motion capture system 640, both spatial and temporal calibration of the experimental setup are performed. The spatial calibration is performed using an array of light emitting diodes (LEDs) that are blinked at a predetermined frequency. Markers are attached to a calibration board to track its position while the calibration of the DVS 630 is performed. By doing so, a transformation between the DVS 630 and the motion capture system 640 were found, as well as intrinsics of the DVS 630.

The temporal calibration is performed by, before each shot of the darts 610, blinking synchronized infrared and white LEDs that are captured by both the motion capture system 640 as well as the DVS 630. This allows calculation of an offset between these clocks at the beginning of each experiment or data collection run. A drift between both clocks after synchronization is negligible because each of experiments only run for a few seconds.

The data collection procedure may be performed to collect a first predetermined number of ball drops and a second predetermined number of toy dart shots. The network may be trained for each individual object that is split into a training set and a testing set.

Further, a series of augmentations may performed on the collected data to ensure that the training set is balanced across a CNN output. However, care must be taken when moving an impact location because an amount of shift varies across a sequence as it depends on a depth due to motion parallax. Because there is a ground truth from the motion capture system 640, a series of event-level augmentations can be generated.

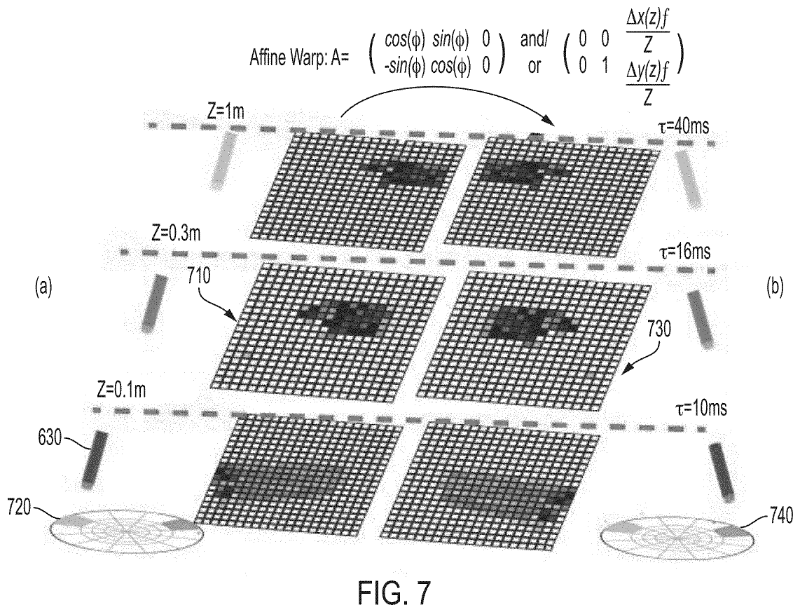

FIG. 7 is a diagram of an augmentation procedure of shifting impact location or rotation about an optical axis, according to embodiments.

Translation augmentations perform a translation per depth value on a windowed event stream 710 (original event set) corresponding to an original trajectory 720, as shown in portion (a) of FIG. 7. Then, rotation augmentations perform an affine rotation (affine warp) on the windowed event stream 710, to generate an augmented event stream 730 (augmented event set) corresponding to an augmented trajectory 740, as shown in portion (b) of FIG. 7.

A random perturbation of the impact location given as a translation may be selected. For each event time window, object events in a corresponding depth plane may be translated, and the resulting event translation may be computed by projecting back on to an image plane.

The transformation can be expressed as a homography independent of depth that allows each set of events to be translated accordingly. New data may be generated by picking a rotation uniformly at random.

Referring again to FIG. 2, the CNN 220 may be trained using the Adam optimizer with a learning rate of 10⁻⁴ and a batch size of 160, according to embodiments. A loss function includes any one or any combination of a multi-objective loss of time to collision mean squared error, p(θ₉) cross entropy loss and p(rₗ) cross entropy loss. An exponential linear unit may be used as an activation function between layers. The CNN 220 may be trained for a specific object and evaluated using the CNN 220 for motion of this object.

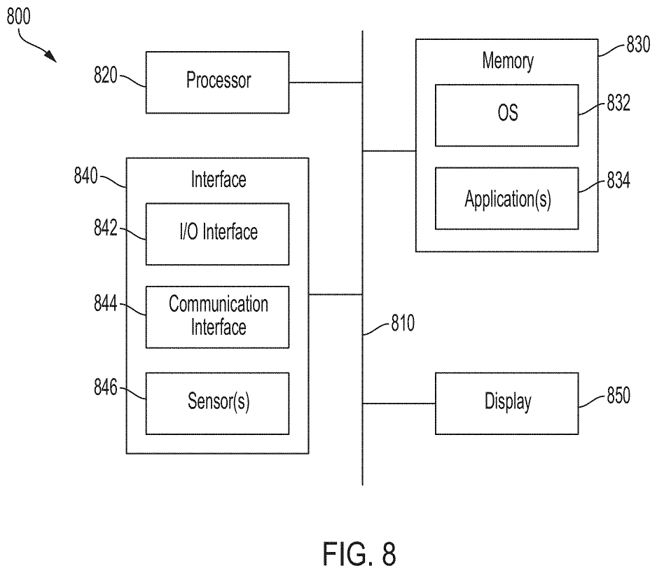

FIG. 8 is a block diagram of an electronic device 800 in which the apparatus 200 of FIG. 2 is implemented, according to embodiments.

FIG. 8 is for illustration only, and other embodiments of the electronic device 800 could be used without departing from the scope of this disclosure.

The electronic device 800 includes a bus 810, a processor 820, a memory 830, an interface 840, and a display 850.

The bus 810 includes a circuit for connecting the components 820 to 850 with one another. The bus 810 functions as communication system for transferring data between the components 820 to 850 or between electronic devices.

The processor 820 includes one or more of a central processing unit (CPU), a graphics processor unit (GPU), an accelerated processing unit (APU), a many integrated core (MIC), a field-programmable gate array (FPGA), or a digital signal processor (DSP). The processor 820 is able to perform control of any one or any combination of the other components of the electronic device 800, and/or perform an operation or data processing relating to communication. The processor 820 executes one or more programs stored in the memory 830.

The memory 830 may include a volatile and/or non-volatile memory. The memory 830 stores information, such as one or more of commands, data, programs (one or more instructions), applications 834, etc., which are related to at least one other component of the electronic device 800 and for driving and controlling the electronic device 800. For example, commands and/or data may formulate an operating system (OS) 832. Information stored in the memory 830 may be executed by the processor 820.

The applications 834 includes the above-discussed embodiments. These functions can be performed by a single application or by multiple applications that each carry out one or more of these functions.

The display 850 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 850 can also be a depth-aware display, such as a multi-focal display. The display 850 is able to present, for example, various contents, such as text, images, videos, icons, and symbols.

The interface 840 includes input/output (I/O) interface 842, communication interface 844, and/or one or more sensors 846. The I/O interface 842 serves as an interface that can, for example, transfer commands and/or data between a user and/or other external devices and other component(s) of the electronic device 800.

The sensor(s) 846 can meter a physical quantity or detect an activation state of the electronic device 800 and convert metered or detected information into an electrical signal. For example, the sensor(s) 846 can include one or more cameras or other imaging sensors for capturing images of scenes. The sensor(s) 846 can also include any one or any combination of a microphone, a keyboard, a mouse, one or more buttons for touch input, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, and a fingerprint sensor. The sensor(s) 846 can further include an inertial measurement unit. In addition, the sensor(s) 846 can include a control circuit for controlling at least one of the sensors included herein. Any of these sensor(s) 846 can be located within or coupled to the electronic device 800. The sensors 846 may be used to detect touch input, gesture input, and hovering input, using an electronic pen or a body portion of a user, etc.

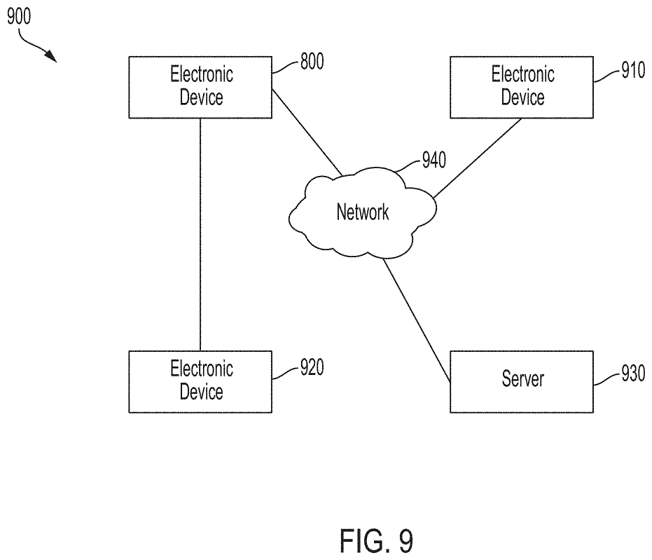

The communication interface 844, for example, is able to set up communication between the electronic device 800 and an external electronic device, such as a first electronic device 910, a second electronic device 920, or a server 930 as illustrated in FIG. 9. Referring to FIGS. 8 and 9, the communication interface 844 can be connected with a network 940 through wireless or wired communication architecture to communicate with the external electronic device. The communication interface 844 can be a wired or wireless transceiver or any other component for transmitting and receiving signals.

FIG. 9 is a diagram of a system 900 in which the apparatus 200 of FIG. 2 is implemented, according to embodiments. The electronic device 800 of FIG. 8 is connected with first external electronic device 910 and/or the second external electronic device 920 through the network 940. The electronic device 800 can be wearable device, an electronic device-mountable wearable device (such as an HMD), etc. When the electronic device 800 is mounted in the electronic device 920 (such as the HMD), the electronic device 800 can communicate with electronic device 920 through the communication interface 844. The electronic device 800 can be directly connected with the electronic device 920 to communicate with the electronic device 920 without involving a separate network. The electronic device 800 can also be an augmented reality wearable device, such as eyeglasses, that include one or more cameras.

The first and second external electronic devices 910 and 920 and the server 930 each can be a device of the same or a different type from the electronic device 800. According to embodiments, the server 930 includes a group of one or more servers. Also, according to embodiments, all or some of the operations executed on the electronic device 800 can be executed on another or multiple other electronic devices, such as the electronic devices 910 and 920 and/or the server 930). Further, according to embodiments, when the electronic device 800 performs some function or service automatically or at a request, the electronic device 800, instead of executing the function or service on its own or additionally, can request another device (such as the electronic devices 910 and 920 and/or the server 930) to perform at least some functions associated therewith. The other electronic device (such as the electronic devices 910 and 920 and/or the server 930) is able to execute the requested functions or additional functions and transfer a result of the execution to the electronic device 800. The electronic device 800 can provide a requested function or service by processing the received result as it is or additionally. To that end, a cloud computing, distributed computing, or client-server computing technique may be used, for example. While FIGS. 8 and 9 show that the electronic device 800 includes the communication interface 844 to communicate with the external electronic device 910 and/or 920 and/or the server 930 via the network 940, the electronic device 800 may be independently operated without a separate communication function according to embodiments.

The server 930 can include the same or similar components 810-850 as the electronic device 800, or a suitable subset thereof. The server 930 can support to drive the electronic device 800 by performing at least one of operations or functions implemented on the electronic device 800. For example, the server 930 can include a processing module or processor that may support the processor 820 implemented in the electronic device 800.

The wireless communication is able to use any one or any combination of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), and global system for mobile communication (GSM), as a cellular communication protocol. The wired connection can include, for example, any one or any combination of a universal serial bus (USB), a high definition multimedia interface (HDMI), a recommended standard 232 (RS-232), and a plain old telephone service (POTS). The network 940 includes at least one communication network, such as a computer network (like a local area network (LAN) or wide area network (WAN)), the Internet, or a telephone network.

Although FIG. 9 illustrates one example of the system 900 including the electronic device 800, the two external electronic devices 910 and 920, and the server 930, various changes may be made to FIG. 9. For example, the system 900 could include any number of each component in any suitable arrangement. In general, computing and communication systems come in a wide variety of configurations, and FIG. 9 does not limit the scope of this disclosure to any particular configuration. Also, while FIG. 9 illustrates one operational environment in which various features disclosed in this patent document, can be used, these features could be used in any other suitable system.

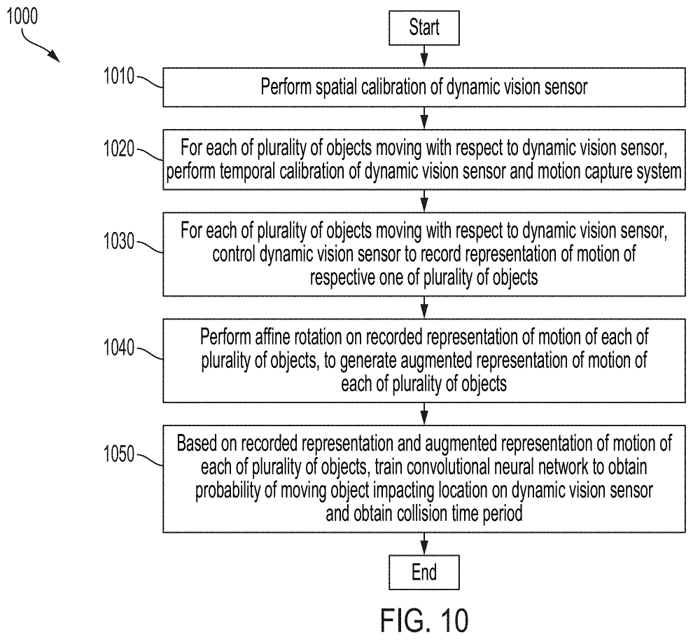

FIG. 10 is a flowchart a training method for fast motion understanding, according to embodiments.

The method 1000 may be performed by at least one processor.

As shown in FIG. 10, in operation 1010, the method 1000 includes performing spatial calibration of a dynamic vision sensor by controlling an array of LEDs to blink at a predetermined frequency and then controlling the dynamic vision sensor to track a position of a calibration board including a plurality of reflective markers.

The method 1000 includes, based on the spatial calibration being performed, for each of a plurality of objects moving with respect to the dynamic vision sensor, performing temporal calibration of the dynamic vision sensor and a motion capture system by controlling the array of LEDs to blink (operation 1020), and based on the temporal calibration being performed, controlling the dynamic vision sensor to record a representation of a motion of a respective one of the plurality of objects (operation 1030).

In operation 1040, the method 1000 includes performing an affine rotation on the recorded representation of the motion of each of the plurality of objects, to generate an augmented representation of the motion of each of the plurality of objects.

In operation 1050, the method 1000 includes, based on the recorded representation of the motion of each of the plurality of objects and the augmented representation of the motion of each of the plurality of objects, training a convolutional neural network to obtain a probability of a moving object impacting a location on the dynamic vision sensor and obtain a collision time period from a time at which the moving object is sensed by the dynamic vision sensor to a time at which the moving object impacts the location on the dynamic vision sensor.

The embodiments of the disclosure described above may be written as computer executable programs or instructions that may be stored in a medium.

The medium may continuously store the computer-executable programs or instructions, or temporarily store the computer-executable programs or instructions for execution or downloading. Also, the medium may be any one of various recording media or storage media in which a single piece or plurality of pieces of hardware are combined, and the medium is not limited to a medium directly connected to electronic device 800, but may be distributed on a network. Examples of the medium include magnetic media, such as a hard disk, a floppy disk, and a magnetic tape, optical recording media, such as CD-ROM and DVD, magneto-optical media such as a floptical disk, and ROM, RAM, and a flash memory, which are configured to store program instructions. Other examples of the medium include recording media and storage media managed by application stores distributing applications or by websites, servers, and the like supplying or distributing other various types of software.

The above described method may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server or a storage medium of server 930.

A model related to the CNN described above may be implemented via a software module. When the CNN model is implemented via a software module (for example, a program module including instructions), the CNN model may be stored in a computer-readable recording medium.

Also, the CNN model may be a part of the apparatus 200 described above by being integrated in a form of a hardware chip. For example, the CNN model may be manufactured in a form of a dedicated hardware chip for artificial intelligence, or may be manufactured as a part of an existing general-purpose processor (for example, a CPU or application processor) or a graphic-dedicated processor (for example a GPU).

Also, the CNN model may be provided in a form of downloadable software. A computer program product may include a product (for example, a downloadable application) in a form of a software program electronically distributed through a manufacturer or an electronic market. For electronic distribution, at least a part of the software program may be stored in a storage medium or may be temporarily generated. In this case, the storage medium may be a server of the manufacturer or electronic market, or a storage medium of a relay server.

The above-described embodiments may provide fast and accurate determinations of object motion, while still maintaining a low power consumption of a DVS in comparison to other imaging devices.

While the embodiments of the disclosure have been described with reference to the figures, it will be understood by those of ordinary skill in the art that various changes in form and details may be made therein without departing from the spirit and scope as defined by the following claims.

What is claimed is:

1. An apparatus for motion understanding, the apparatus comprising:
a memory storing instructions; and
at least one processor configured to execute the instructions to:
obtain, from a dynamic vision sensor, a plurality of events corresponding to an object moving with respect to the dynamic vision sensor;
filter the obtained plurality of events, using a plurality of exponential filters integrating over different time periods, to obtain a plurality of representations of the object moving with respect to the dynamic vision sensor; and
filter the obtained plurality of representations, using a convolution neural network, to obtain a probability of the object impacting a location on the dynamic vision sensor.

2. The apparatus of claim 1, wherein the at least one processor is further configured to execute the instructions to filter the obtained plurality of representations, using the convolution neural network, to obtain a collision time period from a time at which the object is sensed by the dynamic vision sensor to a time at which the object impacts the location on the dynamic vision sensor.

3. The apparatus of claim 2, wherein the dynamic vision sensor is included in a robot, and
the at least one processor is further configured to execute the instructions to control the robot to respond to the object, based on the obtained collision time period and the obtained probability of the object impacting the location on the dynamic vision sensor.

4. The apparatus of claim 3, wherein the at least one processor is further configured to execute the instructions to:
determine whether the location on the dynamic vision sensor is in a moving direction of the object; and
based on the location on the dynamic vision sensor being determined to be in the moving direction of the object, control the robot to move the dynamic vision sensor to avoid the object.

5. The apparatus of claim 2, wherein the at least one processor is further configured to execute the instructions to:
concatenate the obtained plurality of representations; and
filter the concatenated plurality of representations, using the convolution neural network, to obtain the collision time period and the probability of the object impacting the location on the dynamic vision sensor.

6. The apparatus of claim 1, wherein each of the plurality of exponential filters integrates an input signal in a respective one of the different time periods with an exponential kernel:
y[n]=ay[n−1]+(1−α)x[n],
where y[n] is an output signal, x[n] is the input signal, α is a smoothing factor between 0 and 1 and n is a unit of discrete time.

7. The apparatus of claim 1, wherein the plurality of events comprises a three-dimensional volume of events that are sensed by the dynamic vision sensor, and
the plurality of representations comprises a plurality of two-dimensional images of the object moving with respect to the dynamic vision sensor.

8. The apparatus of claim 1, wherein the location on the dynamic location comprises coordinates on a polar grid on a surface plane of the dynamic vision sensor and centered at the dynamic vision sensor.

9. A method of fast motion understanding, the method comprising:
obtaining, from a dynamic vision sensor, a plurality of events corresponding to an object moving with respect to the dynamic vision sensor;
filtering the obtained plurality of events, using a plurality of exponential filters integrating over different time periods, to obtain a plurality of representations of the object moving with respect to the dynamic vision sensor; and
filtering the obtained plurality of representations, using a convolution neural network, to obtain a probability of the object impacting a location on the dynamic vision sensor.

10. The method of claim 9, wherein the filtering the obtained plurality of representations comprises filtering the obtained plurality of representations, using the convolution neural network, to obtain a collision time period from a time at which the object is sensed by the dynamic vision sensor to a time at which the object impacts the location on the dynamic vision sensor.

11. The method of claim 10, wherein the dynamic vision sensor is included in a robot, and
the method further comprises controlling the robot to respond to the object, based on the obtained collision time period and the obtained probability of the object impacting the location on the dynamic vision sensor.

12. The method of claim 11, further comprising determining whether the location on the dynamic vision sensor is in a moving direction of the object,
wherein the controlling the robot comprises, based on the location on the dynamic vision sensor being determined to be in the moving direction of the object, controlling the robot to move the dynamic vision sensor to avoid the object.

13. The method of claim 10, further comprising concatenating the obtained plurality of representations,
wherein the filtering the obtained plurality of representations further comprises filtering the concatenated plurality of representations, using the convolution neural network, to obtain the collision time period and the probability of the object impacting the location on the dynamic vision sensor.

14. The method of claim 9, wherein each of the plurality of exponential filters integrates an input signal in a respective one of the different time periods with an exponential kernel:
y[n]=ay[n−1]+(1−α)x[n],
where y[n] is an output signal, x[n] is the input signal, α is a smoothing factor between 0 and 1 and n is a unit of discrete time.

15. The method of claim 9, wherein the plurality of events comprises a three-dimensional volume of events that are sensed by the dynamic vision sensor, and
the plurality of representations comprises a plurality of two-dimensional images of the object moving with respect to the dynamic vision sensor.

16. The method of claim 9, wherein the location on the dynamic location comprises coordinates on a polar grid on a surface plane of the dynamic vision sensor and centered at the dynamic vision sensor.

17. A non-transitory computer-readable storage medium storing instructions that, when executed by at least one processor, cause the at least one processor to perform the method of claim 9.

18. A training method for fast motion understanding, the training method comprising:
performing spatial calibration of a dynamic vision sensor by controlling an array of light-emitting diodes (LEDs) to blink at a predetermined frequency and then controlling the dynamic vision sensor to track a position of a calibration board comprising a plurality of reflective markers;
based on the spatial calibration being performed, for each of a plurality of objects moving with respect to the dynamic vision sensor:
performing temporal calibration of the dynamic vision sensor and a motion capture system by controlling the array of LEDs to blink; and
based on the temporal calibration being performed, controlling the dynamic vision sensor to record a representation of a motion of a respective one of the plurality of objects; and
based on the recorded representation of the motion of each of the plurality of objects, training a convolutional neural network to obtain a probability of a moving object impacting a location on the dynamic vision sensor.

19. The training method of claim 18, further comprising performing an affine rotation on the recorded representation of the motion of each of the plurality of objects, to generate an augmented representation of the motion of each of the plurality of objects,
wherein the training the convolutional neural network further comprises, based on the recorded representation of the motion of each of the plurality of objects and the augmented representation of the motion of each of the plurality of objects, training the convolutional neural network to obtain the probability of the moving object impacting the location on the dynamic vision sensor and obtain a collision time period from a time at which the moving object is sensed by the dynamic vision sensor to a time at which the moving object impacts the location on the dynamic vision sensor.

20. A non-transitory computer-readable storage medium storing instructions that, when executed by at least one processor, cause the at least one processor to perform the training method of claim 18.
